(19) United States
(12) Patent Application Publication
(10) Pub. No.: US 2009/0320611 A1
(43) Pub. Date: Dec. 31, 2009

(54) ELASTIC COVERING FOR TACTILE SENSORS AND TACTILE SENSOR ARRAY WITH ELASTIC COVERING

(76) Inventors: Gábor Vásárhelyi, Budapest (HU); Csaba Düscö, Dudapest (HU); Attila Kis, Budapest (HU); Balázs Fodor, Sopron (HU)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/516,739

(22) PCT Filed: Nov. 27, 2007
(86) PCT No.: PCT/HU07/00115

§ 371 Date: May 28, 2009

(30) Foreign Application Priority Data
Nov. 30, 2006 (HU) P0600892

(51) Int. Cl. G01D 7/00; B32B 3/30

(52) U.S. Cl. 73/862.046; 428/179

(57) ABSTRACT

The invention is an elastic cover for tactile sensors, said cover comprising an inner surface (11) suitable for being fixed to a surface defined by the tactile sensors, and an outer surface comprising a bump (13). The cover comprises a base layer (10), one surface of which is the inner surface (11), and on its outer surface (12) bumps (13) integral with the base layer (10) are formed. Further, the invention is a tactile sensor array with the elastic cover.

### TECHNICAL FIELD

The invention relates to an elastic covering for tactile sensors and a tactile sensor array fitted with elastic covering.

### BACKGROUND ART

In the industry, tactile sensors are primarily used in robotics, where the elastic cover of tactile sensors plays an extremely important role in the functioning of tactile sensors. The elastic cover defines the basic sensory characteristics as well as the operating mechanism of the sensor unit. In prior art, generally flat covers have been applied for covering tactile sensors.

The paper “Effects of the elastic covering on tactile sensor arrays” written by Gábor Vásárhelyi, Mária Ádám, Éva Vázsonyi, István Bársony and Csaba Dücsö (Proceedings of Eurosensors 2005, Barcelona) describes a separate hemispheric cover arranged on each tactile sensor. The disadvantage of this approach is that the accurate positioning of each cover at the time of installation is a time consuming task, and furthermore it is not described in the paper how shear forces parallel with the surface can be measured reliably.

The design of the elastic cover is to be carried out carefully, because as soon as it is fitted on the sensor, the sensor will no longer measure the surface impacts, but only their distribution coded in a complicated way and passed on by the cover in the form of deformation or mechanical stress distribution. When evaluating the signals of sensors, in order to measure the original impacts, the measured signals must be decoded on the basis of material characteristics, which necessitates the solving of an extremely complicated inverse problem in the case of the prior art covers.

### DESCRIPTION OF THE INVENTION

It is an object of the invention to provide an elastic cover and a tactile sensor array fitted therewith, which is exempt from the above disadvantages of prior art solutions, can be produced and fitted simply and which—due to its geometry and material parameters—simplifies the decoding of mechanical stress. It is a further object to provide such an elastic cover and a tactile sensor array fitted therewith, which also enables the sensing of shear forces in parallel with the surface defined by the tactile sensors. Yet another object is the implementation of the latter shear force sensing function by sensor units which originally measure forces only in a single dimension.

According to a first aspect, the invention is an elastic cover for tactile sensors, said cover comprising an inner surface suitable for being fixed to a surface defined by the tactile sensors, and an outer surface comprising a bump. The cover is characterised by comprising a base layer, one surface of which is the inner surface, and on its outer surface bumps integral with the base layer are formed.

The elastic cover according to the invention can be produced, positioned and fixed simply, and furthermore due to its geometry and material parameters it simplifies the decoding of mechanical stress.

According to a preferred embodiment, the cross section—being parallel with the base layer—of the bumps decreases starting from the base layer. This is advantageous from the aspect of both manufacturing and sophisticated sensing. The bumps are preferably axially symmetric, and the symmetry axes of the bumps are perpendicular to the base layer. The bumps can have e.g. a hemispheric, semi-ellipsoidal, tetrahedron, conic or pyramidal shape. For a direction-selective sensing, in the given case bumps designed as straight ridges may be applied.

The distance between the bumps is preferably between 0.5 mm and 5 mm, and the thickness of the base layer is between 0.2 mm and 2 mm.

According to a second aspect, the invention is a tactile sensor array with an elastic cover, said array comprising tactile sensors arranged along a surface, and being characterised in that on the surface defined by the tactile sensors an inventive elastic cover is arranged.

A specially preferred embodiment comprises tactile sensors suitable for three-dimensional force sensing, and bumps having their topmost points in a region above the tactile sensor. The bumps preferably have a hemispheric shape, and the tactile sensors are beneath the topmost points of the bumps, practically at a distance corresponding to the diameter of the hemispheric shape.

Another preferred embodiment comprises tactile sensors suitable for a single dimensional force sensing, and said bumps have their topmost points between two tactile sensors. For the sake of simple decoding, each of the topmost points of the bumps is preferably arranged in a region above a middle point of the distance between two tactile sensors.

### BRIEF DESCRIPTION OF THE DRAWINGS

The invention will hereinafter be described on the basis of preferred embodiments depicted by drawings, where

FIG. 1 is an axonometric view of a cover according to the invention and used by way of example,

FIG. 2 is a schematic cross sectional view of an embodiment of the tactile sensor array fitted with an elastic cover,

FIGS. 3A and 3B are schematic cross sectional and top views of another embodiment of the tactile sensor array fitted with an elastic cover, and

FIG. 4 is a schematic cross sectional view of another embodiment of the tactile sensor array fitted with an elastic cover.

### MODES FOR CARRYING OUT THE INVENTION

According to our invention, we do not apply a flat cover or a cover with separate hemispheres, but a cover of a geometry detailed below for covering the tactile sensors. The cover according to the invention can be used preferably in tactile sensors of three degrees of freedom, i.e. in tactile sensors which measure not only a force component perpendicular to the surface, but also the two shear direction components parallel with the surface. However, according to the discussion below, it may also be used in sensors of one degree of freedom. By way of example, a tactile sensor of three degrees of freedom is described in the paper referred to in the introduction.

In association with creating the elastic cover and the array, the following considerations apply.
It is advantageous for a tactile sensor array, if the first contact points are above the sensor elements when touching an object, so that the force is concentrated thereto in order to ensure efficient sensing.
The cover should be elastic, not too rigid, not too sticky, not too slippery, resembling the tactile structure of the skin as closely as possible.
The material should be applied as simply as possible, preferably with a coding mechanism that can be decoded in a linear way.
A material should be applied which retains independence during coding i.e. independent decoding ability of the three components of the surface impact.

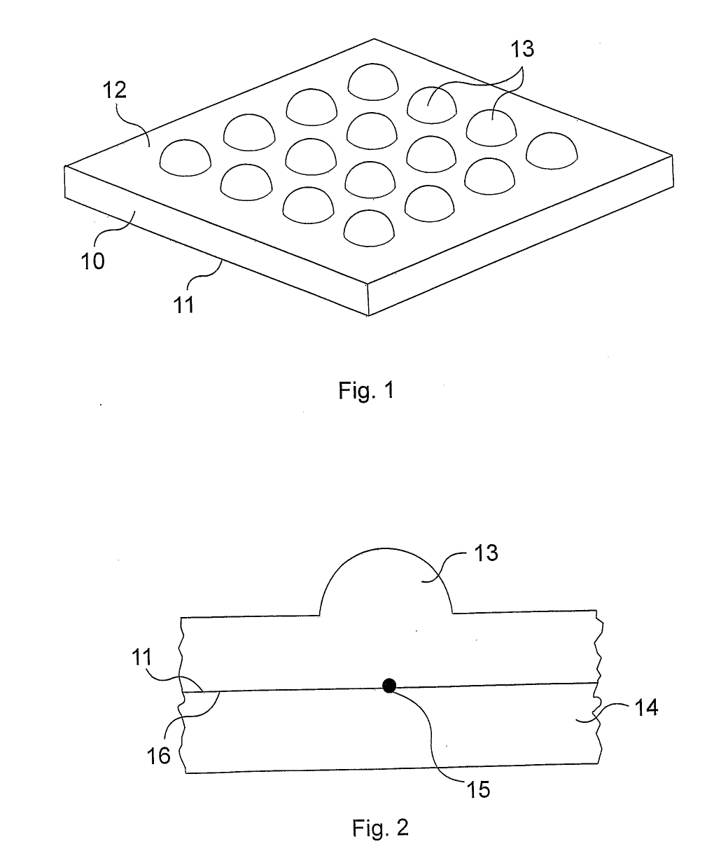

The elastic cover according to the invention and shown in FIG. 1 comprises an inner surface 11 designed in a way so as to enable fixing on a surface defined by the tactile sensors, and an outer surface 12 comprising bumps 13. The basis of the cover is a base layer 10, one surface of which is the inner surface 11, and the bumps 13 integral with the base layer 10 are formed on its outer surface 12.

The figure shows that the cross section—in parallel with the base layer 10—of the bumps 13 gradually decreases as the distance grows from the base layer 10. Preferably, the bumps 13 are designed in axial symmetry where the axis of symmetry of each bump 13 is perpendicular to the base layer 10. The bumps 13 preferably have a hemispheric, semi-ellipsoidal, tetrahedron, conic or pyramidal shape.

The cover shown in FIG. 1 is designed with hemispheric bumps for the tactile sensor array of 4×4 elements. The covering structure according to the invention is extremely advantageous, because it enables sensing with three degrees of freedom on three dimensional tactile sensor arrays arranged in one plane. The base layer 10 is preferably of constant thickness, but due to structural or other considerations, it may also be implemented with a varying thickness. The bumps 13 must be located on the base layer 10 in accordance with the arrangement of tactile sensors, as described below.

As long as only pressure gauge (one degree of freedom) sensors existed, the elastic cover did not play any special role, because it only functioned as a type of spatial low-pass filter, with the effect mainly exerted in an attenuating manner. Consequently, in the case of those sensors, a cover with a flat surface was sufficient.

Contrary to a flat surface—where the sensor below the cover ‘senses’ the sum total of forces exerted on the surface of the cover above—the bumps, preferably hemispheres according to the invention, localize the attacking force at their topmost points with high efficiency. Because they protrude from the surface, in the case of a tactile event they represent the first contact points, around which generally the highest mechanical stresses are concentrated. In this way the sensing efficiency can be high. At the same time, in the case of holding functions, the hemispheres provide better adherence, and thereby they may support an improved surface contact.

When selecting the material for the elastic cover, the following factors must be considered. It is advisable to apply a material which is
transparent, so that it can be easily positioned on the sensor surface,
appropriately flexible so that the mechanical stresses therein are local during use, i.e. there should be no crossover between the impacts of bumps (e.g. hemispheres) above each sensor element,
mouldable and dimensionable in liquid state, and easily removable from the mould after setting,
not sticky, at the same time allowing easy gluing to the sensor.

By way of example, a suitable raw material is the two component RT-601 silicon rubber produced by Wacker Chemie AG. This material has a high homogeneity and behaves approximately in a linear way under small load, consequently it can be described with a linear continuum mechanical model. In the case of a linear system, in a way well-known in modelling, only two elasticity parameters of the material must be known. The Poisson ratio defining incompressibility is 0.5 with a good approximation in the case of rubber, which practically means that rubber cannot be compressed in volume. Young's modulus defining hardness is approx. 2.4 MPa in the case of the material used as an example.

To make an appropriate elastic cover, first a mould is to be made. Once the actual dimensions are known, various processes can be applied. In the case of bumps of a diameter of approx. 400 μm, we have etched a standard silicon plate in an isotropic way with the appropriate mask, and in the case of bumps having a diameter of 2 mm, steel roller balls with a given size were pressed in given positions into a smoothly polished aluminium plate. As an alternative, even a plastic mould can be applied in an arbitrary size.

The liquid, bubble-free stirred silicon rubber is to be poured into the mould. The smoothness of the surface opposite the mould can be ensured by a cleaned glass sheet placed on spacers of appropriate thickness. At the end of the setting time, the rubber can be separated from the mould and the glass, and it can be cut to size to achieve the proper lateral dimension. Using a thin layer of adhesive, the rubber layer can then be glued to the tactile sensor array. This adhesive can be the base layer in a liquid state or as an alternative a rubber glue having similar mechanical characteristics.

In designing the elastic cover, actually there is no need to insist on a hemispheric geometry. Any bumps meeting the above listed requirements can be applied.

FIG. 2 shows just one part of the tactile sensor array used by way of example and fitted with an elastic cover. The tactile sensors 15 are designed to allow a three dimensional sensing of the applied force, and they are arranged along the surface 16 of the carrier plate 14. The inner surface 11 of the cover is fixed—preferably by gluing—to the surface 16 defined by the tactile sensors 15.

In the embodiment shown in FIG. 2, the elastic cover comprises hemispheric bumps 13 which have their topmost points above or generally in the region above the tactile sensors 15.

The mechanical stress transferring characteristics of the elastic cover having the bumps 13 of hemispheric geometry and shown as a schematic cross sectional view in FIG. 2 have been examined by a finite element model. The virtual layer has been subjected to various magnitudes of loads perpendicular to the surface and also in a shear direction, and in each case the mechanical stress distribution and deformation arising in the material have been examined. To do so, we have assumed that the various tactile sensor elements provide signals proportional with the local deformation of the rubber, the stress tensor components or the deformation tensor components. It has been proven by our experiments that the requirements of the independent coding of surface force components and a simple recalculation can be met by the hemispheric geometry, if the tactile sensor elements 15 shown in a schematic view in the figure are located below the centre of the hemisphere, roughly at one diameter distance from the topmost point of the hemisphere.

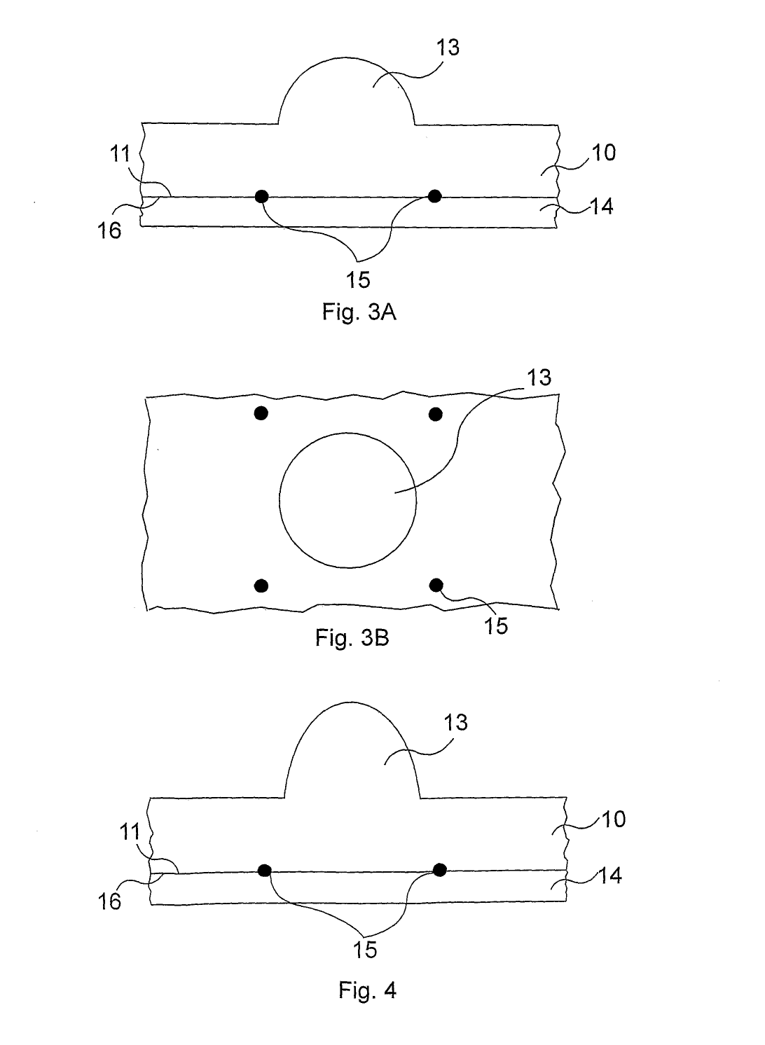

It is also possible by means of the elastic cover according to the invention to obtain signals characterising the shear forces from (single dimensional) tactile sensor arrays measuring only pressure-like components. The essence of the approach according to the invention is that according to FIGS. 3A and 3B, an elastic bump 13 is placed above not one but four tactile sensor elements 15, and by combining the signals of the four tactile sensors 15, a sensing function is obtained in three degrees of freedom. In this case, consequently the array comprises such bumps 13, the highest point of which falls into the region above the middle of the distance between two tactile sensors 15 or roughly above the middle, in other words in the region above the middle point.

In the top view according to FIG. 3B, the highest point of the bump 13 is between the tactile sensors 15 of diametric arrangement. To achieve direction-selective sensing, it is also possible that the highest point of the bump 13 is not between the diametric tactile sensors, but between the neighbouring tactile sensors 15. In this case, of course, it is impossible to sense the shearing forces being perpendicular to the straight line defined by the tactile sensors 15.

The 1D→3D conversion is possible by meeting the following conditions:
In the case of a normal load, the stress/deformation component perpendicular to the surface arising in the elastic material is symmetric, and in the case of a lateral load it is asymmetric.
In the case of a normal load there is no asymmetric, and in the case of a lateral load there is no symmetric component in the surface/perpendicular stress/deformation component, i.e. there is no crossover between the measured effects of the various surface force components measured simultaneously.
The coding mechanism of elastic material is simple, and it is possibly linear.

If the above three conditions are met, the components of our new 3D sensor element can be outlined by simple mathematics. The component normal to the surface will be proportional to the average of the signals from the four elements, while the two lateral components can be derived from the difference of signals provided by opposite elements, taking into consideration the appropriate proportionality factor. The pressure to the four tactile sensors is passed on by the material of the base layer according to the invention, enabling thereby the application of a simple sensor model.

If the topmost point of the bump 13 is not exactly above the middle, the simple decoding option is retained, because the calculation is to be expanded only by the compensation of the effect stemming from the difference in distance. It is of course also possible to apply the arrangement shown in FIG. 3 with three dimensional tactile sensor elements.

FIG. 4 shows a schematic cross sectional view on the details of a cover which is especially beneficial and comprises semi-ellipsoidal bumps. The advantage of this design is that the protruding top of the bump is more sensitive in passing the shearing direction forces to the tactile sensors.

A design is also possible where the bumps are constructed as straight ridges. In the longitudinal direction of bumps, sensing is the same as with the flat covering, while in a crosswise direction a sensing function provided by the hemispheric bumps can be obtained. In this way a direction selective tactile sensing is achieved. Of course, it is also possible that the bumps are not located in a straight line, but they are situated along a fractional line or a curved line enabling the required direction selectivity.

The distance of bumps 13 from each other is preferably between 0.5 mm and 5 mm. The sensory function of a human finger enabling a resolution of some 1 mm falls into this region. In the case of hemispheric bumps, their radius is preferably not less than 0.15 mm.

The thickness of the base layer 10 is preferably between 0.2 mm and 2 mm. If the base layer is thinner, the cover becomes difficult to handle, tears easily and a sensing model provided by the passing of pressure by the base layer is not available.

Of course, the invention is not limited to the preferred embodiments shown by way of example in the figures, but further modifications are possible within the scope of the claims.

1. An elastic cover for tactile sensors for three-dimensional force sensing, comprising:
a surface defined by the tactile sensors;
an inner surface for being fixed to the surface defined by the tactile sensors,
an outer surface comprising bumps including a height and topmost points, the bumps for localizing forces of tactile events at the topmost points, and
a base layer, one surface of which is the inner surface, and wherein the bumps on the outer surface are integral with the base layer,
wherein the base layer has a thickness for transferring forces of tactile events in an elastic material of the base layer to the tactile sensors, said thickness being roughly equal with the height of the bumps.

2. The elastic cover according to claim 1, wherein the thickness of the base layer is between about 0.2 mm and about 2 mm.

3. The elastic cover according to claim 1, wherein the bumps have at least one of a hemispheric, semi-ellipsoidal, tetrahedron, conic and pyramidal shape.

4. The elastic cover according to claim 1, wherein the bumps are formed as straight ridges.

5. The elastic cover according to claim 1, wherein the distance between the bumps is between about 0.5 mm and about 5 mm.

6. (canceled)

7. (canceled)

8. (canceled)

9. (canceled)

10. The elastic cover according to claim 2, wherein the distance between the bumps is between about 0.5 mm and about 5 mm.

11. The elastic cover according to claim 3, wherein the distance between the bumps is between about 0.5 mm and about 5 mm.

12. The elastic cover according to claim 4, wherein the distance between the bumps is between about 0.5 mm and about 5 mm.

13. A tactile sensor array with an elastic cover, comprising:
tactile sensors arranged along a surface, wherein the surface is defined by the tactile sensors and an elastic cover for the tactile sensor includes:
an inner surface for being fixed to the surface defined by the tactile sensors,
an outer surface comprising bumps including a height and topmost points, the bumps for localizing forces of tactile events at the topmost points, and
a base layer, one surface of which is the inner surface, and wherein the bumps on the outer surface are integral with the base layer,
wherein the base layer has a thickness transferring forces of tactile events in an elastic material of the base layer to the tactile sensors, said thickness being roughly equal with the height of the bumps.

14. The array according to claim 13, wherein the tactile sensors are for three-dimensional force sensing, and the bumps and have a generally hemispheric shape, wherein the tactile sensors are beneath the topmost points of the bumps, at a distance corresponding to a diameter of the generally hemispheric shape.

15. The array according to claim 13, wherein the bumps are arranged around a middle area between four tactile sensors of diametric arrangement, wherein the tactile sensors are arranged outside of a part of the surface defined by the tactile sensors which is covered by the bumps.

16. The array according to claim 15, wherein the tactile sensors are single dimensional force sensing sensors.

17. The array according to claim 13, wherein the thickness of the base layer is between about 0.2 mm and about 2 mm.

18. The array according to claim 17, wherein the distance between the bumps is between about 0.5 mm and about 5 mm.

19. The array according to claim 13, wherein the bumps have at least one of a hemispheric, semi-ellipsoidal, tetrahedron, conic and pyramidal shape.

20. The array according to claim 19, wherein the distance between the bumps is between about 0.5 mm and about 5 mm.

21. The array according to claim 13, wherein the bumps are formed as straight ridges.

22. The array according to claim 21, wherein the distance between the bumps is between about 0.5 mm and about 5 mm.

23. The array according to claim 13, wherein the distance between the bumps is between about 0.5 mm and about 5 mm.
